(19) United States
(12) Patent Application Publication
(10) Pub. No.: US 2006/0090955 A1
(43) Pub. Date: May 4, 2006

(54) Microphone diaphragms defined by logarithmic curves and microphones for use therewith

(76) Inventor: George Cardas, Bandon, OR (US)

Correspondence Address: DORSEY & WHITNEY LLP, 555 CALIFORNIA STREET, SUITE 1000, SUITE 1000, SAN FRANCISCO, CA, 94104, US

(21) Appl. No.: 10/981,802

(22) Filed: Nov. 4, 2004

(51) Int. Cl. H04R 7/00; G10K 13/00

(52) U.S. Cl. 181/158

(57) ABSTRACT

Microphone diaphragms are provided having an active area with a periphery defined by at least a portion of a logarithmic curve. In some embodiments, the periphery is defined by at least a portion of a golden spiral. The microphone diaphragms may be used in pressure microphones.

### TECHNICAL FIELD

The present invention relates to microphone diaphragms.

### BACKGROUND OF THE INVENTION

Presently, diaphragm microphones use round or rectangular diaphragm mounting structures. These round or rectangular shapes have recurring cord lengths between their peripheral edges that result in predictable resonance and phase shifts in their transduced signals. Briefly, perpendicular lines from opposing peripheral edges of the circular or rectangular structures converge on a common point or line. This results in dimensional and dynamic duplications in the mounted diaphragm and complicates the process of signal absorption and reflection. Accordingly, microphones employing round or rectangular microphone diaphragms exhibit grouped time delays and native resonances.

There is therefore a need for a microphone diaphragm that smoothes signal absorption and reflection, reducing group time delays and native resonances seen in present microphones.

### SUMMARY OF THE INVENTION

A microphone diaphragm is provided having an edge, at least a portion of which is defined by a logarithmic curve. The logarithmic curve may be a portion of a golden spiral. The microphone diaphragm may be in the shape of an ellipse where the ellipse has a ratio between a major an a minor diameter equal to about 1.62 to 1. The microphone diaphragm may have a drop-shaped periphery defined by two intersecting logarithmic curves.

Microphone diaphragms according to the present invention may be used in pressure microphones.

### BRIEF DESCRIPTION OF THE DRAWINGS

FIG. 1 illustrates a line depicting a golden spiral, at least a portion of which is utilized in the microphone diaphragms of FIGS. 3, 4 and 5

FIG. 2 is an exploded view of a microphone diaphragm of the present invention having a peripheral edge defined by four logarithmic curves.

FIG. 3 is a plan view of a microphone diaphragm having a golden ellipse shape.

FIG. 4 is an embodiment of a microphone diaphragm of the present invention having a drop shape.

FIG. 5 is a further embodiment of a microphone diaphragm of the present invention having a horn shape.

FIG. 6 is an exploded view of a dual back plate microphone capsule utilizing a microphone diaphragm according to the present invention.

FIG. 7 is a schematic illustration of an electrical circuit utilized with a pressure microphone according to the present invention.

FIG. 8 is a graph of the output noise of a microphone utilizing a diaphragm of the present invention.

FIG. 9 is a graph of the output noise, similar to FIG. 8, of a microphone utilizing a conventional diaphragm.

FIG. 10 is a graph of the output noise, similar to FIG. 8, of a reference microphone.

### DETAILED DESCRIPTION OF PREFERRED EMBODIMENTS

The present invention provides microphone diaphragms where the peripheral edge or periphery of the diaphragm is defined, at least in part, by a logarithmic curve, as that term is defined herein. In particular, the shapes of the microphone diaphragm of the present invention are derived at least in part from sections of a golden spiral, as that term is defined herein.

A “logarithmic curve” as used herein may generally be expressed in polar notation as r=ae^{(kθ)}; where r is the distance from an origin, θ is the angle the graph is open to, and a and k are constants.

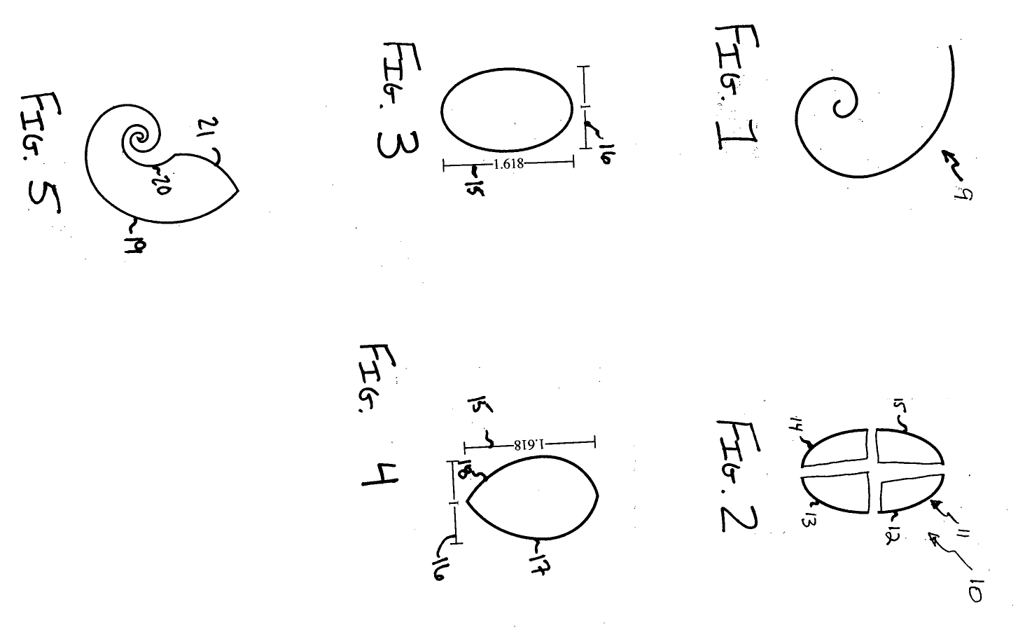

FIG. 1 depicts a golden spiral 9. A “golden spiral”, as used herein, is mathematically expressed as a logarithmic curve having a value of k where the lengths of the portions of the axes cut off by the spiral fit the golden ratio. The golden ratio, as used herein and known in the art, is (1+√5)2≈1.618. The golden ratio is also referred to by the Greek symbol phi, φ. Accordingly, for a golden spiral, k=(2/π)*ln(φ), for any value of the constant a.

Golden spirals are also referred to in the art and historical literature as mirabilis, logarithmic, equiangular, geometrical, or proportional curves. The golden spiral has interesting properties and has been studied historically and demonstrated in nature, such as in the shape of Nautilus shells, human embryos, and other natural phenomena. The golden spiral is a curve having whorls expanding in an unchanging ratio. Sectors cut off by successive radii at equal or constant vector angles are similar in every respect. Generally, in a golden spiral, the size of the spiral increases, but the shape is unaltered.

Although the golden ratio and golden spiral have been precisely mathematically defined above, various manufacturing tolerances and considerations will be taken into account, resulting in the exact mathematical ratios not always being precisely achieved when implementing microphones and microphone diaphragms having the described shapes. Microphone diaphragms according to the present invention, accordingly, may have edges approximately defined by the golden spiral or have proportions approximated by the golden ratio. The closer the final dimensions are to the exact ratios or curves, generally the more benefit is achieved by embodiments of the invention. Accordingly, microphone diaphragms having peripheral edges defined in part by the golden ratio preferably are defined by the ratio of 1.618, but may in practice have a ratio of about 1.618, ranging from 1.61 to 1.62 in some embodiments, from 1.6 to 1.63 in some embodiments, and 1.5 to 1.7 in some embodiments, with some or all of the described advantages of the invention retained. In an analogous fashion, deviations from the precise mathematical definition of the golden spiral may be used in forming the peripheral edges of microphone diaphragms according to the present invention.

The present invention provides microphone diaphragms having at least a portion of their periphery defined by a segment of a logarithmic curve. In some embodiments, the periphery of the diaphragm is defined by a portion of a golden spiral.

An embodiment of a microphone diaphragm 10 of the present invention having a peripheral edge 11 is shown in FIG. 2. As used herein, the term peripheral edge means an edge of an active area of the diaphragm material. The active area is the area of the diaphragm material that responds to sound waves. The peripheral edge can include the actual edge of the diaphragm material, if the entire material is responsive to incident sound waves, or may be a peripheral edge defined by a restraining ring or clamp, as discussed further below. Peripheral edge 11 has the shape of an ellipse, which, as illustrated in FIG. 2 is formed from a plurality of logarithmic curve segments or curves 12, 13, 14 and 15. FIG. 2 depicts microphone diaphragm 10 as having four quadrants or sectors, each with one of the curves or edges 12, 13, 14 and 15, respectively. Such peripheral curve segments are each preferably formed by one or more logarithmic curves and more preferably by a portion a golden spiral. FIG. 3 depicts a microphone diaphragm having a shape of a golden ellipsoid, where the ratio of the major axis 15 to the minor axis 16 is the golden ratio and is about 1.618. FIG. 4 depicts a microphone diaphragm having a drop-shape periphery, again having a major 15 to minor 16 axis ratio of the golden ratio, but also where the edges 17 and 18 are defined by a portion of the golden spiral. FIG. 5 depicts a microphone diaphragm having a horn shape periphery, where three edges 19, 20, and 21 are defined by portions of a golden spiral.

Microphone diaphragms according to the present invention may be used with pressure microphones for voice and/or music. FIG. 6 depicts an exploded view of a dual back plate microphone capsule 26 having a diaphragm 30 therein. The diaphragm 30 is preferably a flexible member having a thickness ranging from 0.5 to 50 millimeters and preferably ranging from four to six millimeters. The diaphragm is preferably flexible and solid, and is made from any suitable material such as mylar or another flexible polyester. Other suitable materials for diaphragm 30 include thin metals, such as nickel or very thin gold foil. The diaphragm 30 is typically implemented by stretching and affixing the diaphragm over a spacer 31 affixed in a suitable manner to a backplate 32. In such a manner, the spacer 31 and/or the backplate 32 define the active area of the diaphragm, that is the portion of the diaphragm radially inside the spacer 31, as well as the peripheral edges of the diaphragm 30, that is the periphery of the active area of the diaphragm that borders the spacer 31. Accordingly, the spacer 31 and/or the backplate 32 may be provided to achieve the diaphragm shapes described above, although it is appreciated that other diaphragm materials and methods of forming a diaphragm may be used, as known in the art.

A securing ring 36 may be placed over the diaphragm. One or more spacers 37 connect the back plate 32 to an optional second portion 38 of the capsule 26, which can be identical to the first portion of the capsule 26. The second portion 38 preferably includes another diaphragm 30, backplate 32 and spacer 31. For simplicity, the diaphragm 30 of second portion 38 is not shown in FIG. 6. Each of the diaphragm 30, spacer 31 and securing ring 36 are provided with a plurality of circumferentially spaced-apart holes 41 which are registerable to receive a respective plurality of bolts or other fasteners (not shown) which threadedly or otherwise secure to the backplate 32, such as within threaded holes 42 in the backplate. Alternatively, the holes 42 in at least one of the backplates 32 can be through holes such that the bolts or other fasteners also extend through such backplate so as to secure a first portion of the capsule 36 to the second portion 38 of the capsule 36.

Diaphragm 30 of capsule 26 is open to ambient sound or pressure variations on one side and controlled from the variations on the other. The motion of the diaphragm is related to the difference between ambient pressure on the open side and the pressure of the controlled volume of air contained by a backplate 32 and spacer 31 on the other side. The backplate is preferably provided with a plurality of spaced-apart holes or apertures 46 that extend through the backplate and serve to accommodate the volume of air or other fluid displaced by the movement of diaphragm 30. The holes 46, which can reduce in diameter as they extend away from diaphragm 30 and spacer 31, are particularly useful for facilitating the damping process in larger microphones.

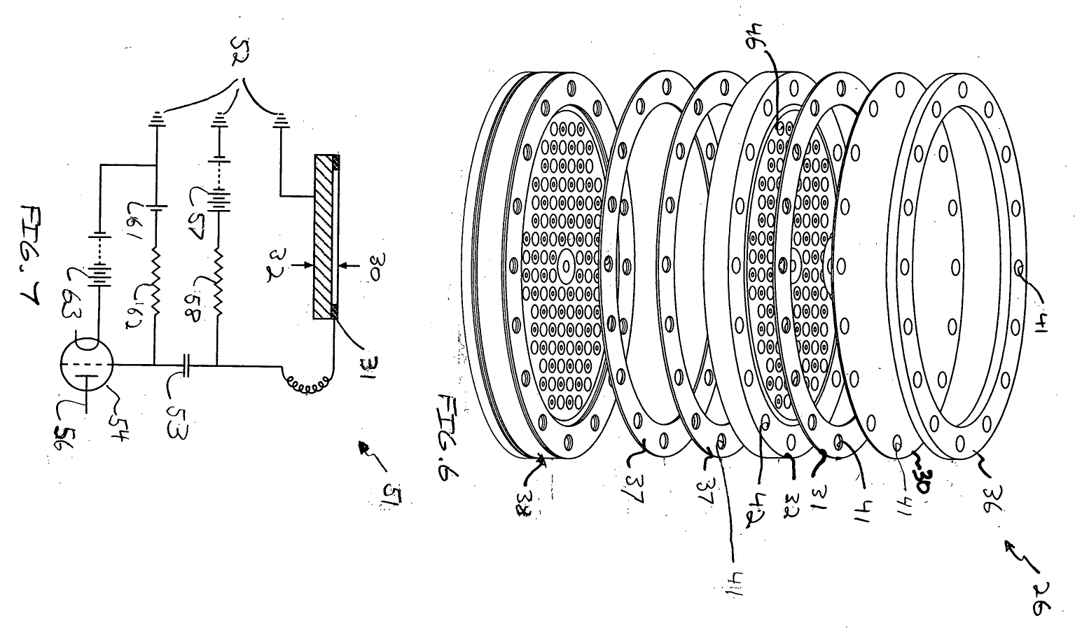

Various means of transduction are utilized to convert diaphragm motion to an electrical signal. In this regard, a portion of the capsule 26 of a pressure microphone and associated circuitry are illustrated in FIG. 7. A simple triode amplification and biasing circuit 51, which can provide some amplification or act as an impedance matching circuit, is shown in FIG. 7. Backplate 32 is shown in circuit 51 as being coupled to ground 52, while the signal from diaphragm 30 passes through an isolation capacitor 53 before reaching a device suitable for voltage modulation, such as vacuum tube 54, having output 56. It is appreciated that a metal-oxide semiconductor field-effect transistor or similar device can be utilized in circuit 51 instead of vacuum tube 54. A suitable voltage source such as capsule bias battery 57 and a bias resistor 58, preferably having a resistance of approximately 5M ohms, are coupled in series between ground 52 and a node disposed between diaphragm 30 and capacitor 53. Circuit 51 further includes a grid bias 61 and a resistor 62 coupled in series between ground 52 and a node disposed between capacitor 53 and vacuum tube 54. A suitable voltage source such as a tube B+ voltage 63 is coupled in series between the ground 52 and the vacuum tube 54. In general, movement of the diaphragm 30 in response to sound waves generates an electrical output that is relatively small and of high impedance. Such electrical output serves to the modulate voltage 63 to produce a voltage at output 56 that is a larger signal and of lower impedance. The output of circuit 51 is low and thus typically requires substantial amplification for use, for example by a board recorder or preamplifier.

When diaphragm shapes described above are used in the dual back plate microphone capsule of FIG. 6, a labyrinth, acoustic, low pass filter is formed where traditional round capsule resonance at the filter cutoff point is reduced, minimized, or eliminated while the slope is lengthened or softened. This results in a clearer impulse response at all frequencies.

Forming microphone diaphragms having one or more edges defined by a logarithmic curve, or golden spiral, scales cord lengths in a linear progression. Perpendiculars from adjacent sections of the edges do not converge on a common point or line, so the edges of the diaphragm intercept continuously varying portions of oncoming high frequency waves. In this manner, a logarithmically shaped diaphragm reduces dimensional and dynamic duplications in the mounted diaphragm and smoothes the process of signal absorption and reflection, reducing the grouped time delays and native resonances experienced in conventional diaphragm microphones. As result of this reduced resonance at the critical frequency crossover point, where the high pass filter and low pass filter functions of a directional microphone model create its directionality, a flatter frequency response is achieved to a lower frequency than in conventional microphones. Normal diffraction effects are minimized or avoided, since the edges of the capsule intercept continuously varying portions of oncoming high frequency waves. This is in contrast to conventional static, or fixed interception of waveforms that generate high-Q factor resonant peaks. In practice, a microphone employing diaphragms according to the present invention allows for the maintenance of relatively flat frequency response in the off axis, while in directional mode, without having to place the front to rear path length above, or in the higher regions of the audio band. This retains the lower noise of a larger diaphragm capsule.

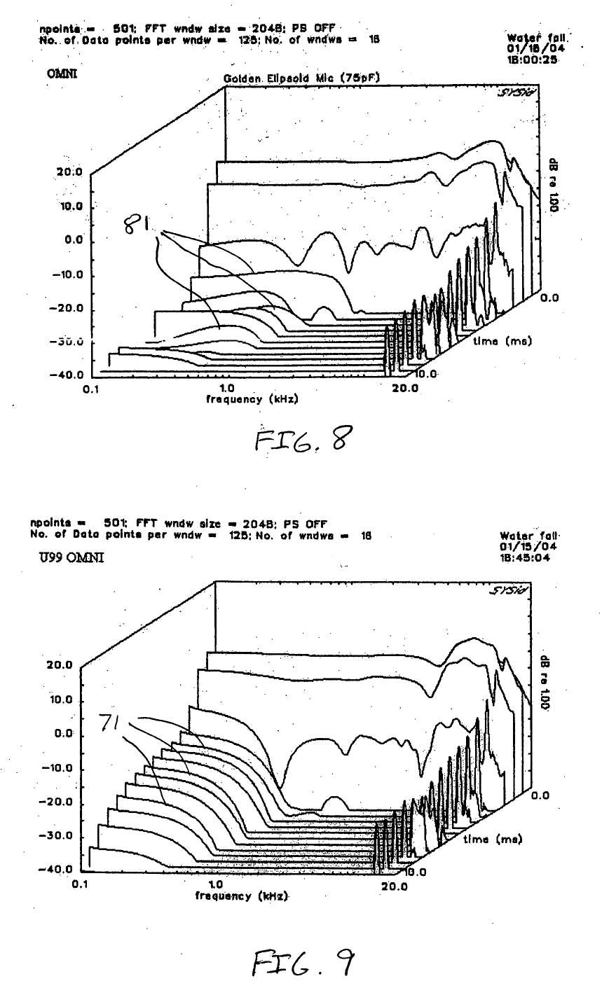

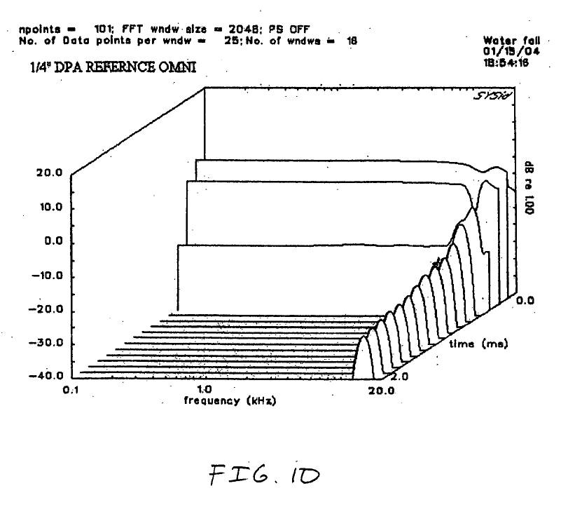

A three-dimensional graph of the output noise, measured in decibels, as a function of frequency and time of a suitable microphone, such as a U99 microphone manufactured by Soundelux of Los Angeles, Calif., utilizing a diaphragm 10 of the type illustrated in FIG. 2 is shown in FIG. 8. A similar graph for such a U99 microphone having a conventional diaphragm therein, for example a large round diaphragm that is identical in all respects except for shape to the diaphragm pertaining to FIG. 8 is shown in FIG. 9. A similar graph for a reference microphone having a diaphragm that is sufficiently small to move resonance modes out of band is shown in FIG. 10. Each of the microphones illustrated in FIGS. 8-10 is a non-directional mode microphone. As can be seen from FIG. 9, there is a defined linear decay pattern 71 for some frequencies and ranges of frequencies. Decay pattern 71 is called a resonant mode and is very identifiable to the human ear. In contrast, the decay pattern 81 for the microphone utilizing a diaphragm of the present invention, shown in FIG. 8, is irregular, of higher order and less energy. Such a pattern is much more difficult for the human ear to identify and ultimately manifests as clearer sound.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A microphone diaphragm comprising a flexible body having an active area, the active area having a peripheral edge, at least a portion of the peripheral edge defined by a logarithmic curve.

2. A microphone diaphragm according to claim 1, wherein the logarithmic curve is at least a portion of a golden spiral.

3. A microphone diaphragm according to claim 1, wherein the peripheral edge has the shape of an ellipse.

4. A microphone diaphragm according to claim 1 where the ellipse has a major diameter and a minor diameter and a ratio between the major diameter and the minor diameter approximating 1.62 to 1.

5. A microphone diaphragm according to claim 1, wherein the peripheral edge forms a portion of an ellipsoid.

6. A microphone diaphragm according to claim 1, wherein at least a portion of the peripheral edge is defined by first and second logarithmic curves.

7. A microphone diaphragm according to claim 6 wherein the first logarithmic curve adjoins the second logarithmic curve.

8. A microphone diaphragm according to claim 1 wherein the peripheral edge is formed solely from logarithmic curves.

9. A microphone diaphragm according to claim 6, wherein the microphone diaphragm has a drop-shaped periphery defined by the first and second logarithmic curves.

10. A dual back plate microphone capsule for use with the microphone diaphragm of claim 1, the dual back plate microphone comprising a back plate defining the active area, a spacer secured to the back plate, and the microphone diaphragm secured to the spacer.

11. A microphone diaphragm according to claim 1, wherein the peripheral edge is defined by first, second, and third logarithmic curves.

12. A microphone diaphragm according to claim 11, wherein the peripheral edge has a horn shape.

13. A microphone diaphragm according to claim 1, wherein the active area is an area of the flexible body response to sound waves.
